(19) United States
(12) Patent Application Publication
(10) Pub. No.: US 2015/0095266 A1
(43) Pub. Date: Apr. 2, 2015

(54) VEHICLE OPERATIONAL COST DISPLAY SYSTEM AND METHOD

(71) Applicant: FORD GLOBAL TECHNOLOGIES, LLC, Dearborn, MI (US)

(72) Inventors: Brian 'Ninja' Thomas Soo, Farmington Hills, MI (US); Barney D. Nefcy, Novi, MI (US); David Paul Tourner, Novi, MI (US)

(21) Appl. No.: 14/040,648

(22) Filed: Sep. 28, 2013

(51) Int. Cl. G06Q 50/30; G06Q 30/02

(52) U.S. Cl. CPC G06Q 50/30; G06Q 30/0283; G06Q 30/0284
USPC 705/412

(57) ABSTRACT

A vehicle operational cost display system includes a user interface adapted for entry of cost of fuel for operation of a vehicle; a central processing unit interfacing with the user interface, the central processing unit having a calculator function adapted to calculate total operational cost of the vehicle based on the cost of fuel for operation of the vehicle and distance traveled; and a display interfacing with the central processing unit, the display adapted to display the total operational cost of the vehicle. A vehicle operational cost display method is also disclosed.

### FIELD

Illustrative embodiments of the disclosure relate to systems and methods for determining operational costs of vehicles. More particularly, illustrative embodiments of the disclosure relate to a vehicle operational cost display system and method which calculates the operational cost of a vehicle based on fuel cost input and displays the calculate operational cost to an operator of the vehicle.

### BACKGROUND

Plug-in HEVs (hybrid electric vehicles) provide a vehicle operator with an MPGE (Distance Per Gallon Electric or Equivalent) calculation. MPGE is the industry standard but does not take into account the cost of electricity needed to charge the high capacity battery of the vehicle. The total operational cost of a PHEV (plug in hybrid electric vehicle) or extended range vehicle is not available to the vehicle operator.

Accordingly, a vehicle operational cost display system and method which calculates the operational cost of a vehicle based on fuel cost input and displays the calculate operational cost to an operator of the vehicle is needed.

### SUMMARY

Illustrative embodiments of the disclosure are generally directed to a vehicle operational cost display system which calculates the operational cost of a vehicle based on fuel cost input and displays the calculate operational cost to an operator of the vehicle. An illustrative embodiment of the system includes a user interface adapted for entry of cost of fuel for operation of a vehicle; a central processing unit interfacing with the user interface, the central processing unit having a calculator function adapted to calculate total operational cost of the vehicle based on the cost of fuel for operation of the vehicle and distance traveled; and a display interfacing with the central processing unit, the display adapted to display the total operational cost of the vehicle.

Illustrative embodiments of the disclosure are further generally directed to a vehicle operational cost display method. An illustrative embodiment of the method includes entering a fuel cost for a vehicle and calculating and displaying a total operational cost of the vehicle based on the fuel cost, distance per unit volume of fuel consumed and distance traveled by the vehicle.

### BRIEF DESCRIPTION OF THE DRAWINGS

Illustrative embodiments of the disclosure will now be described, by way of example, with reference to the accompanying drawings, in which:

FIG. 1 is a block diagram of an illustrative embodiment of a vehicle operational cost display system suitable for an HEV;

FIG. 2 is a block diagram of an illustrative embodiment of a vehicle operational cost display method suitable for an HEV;

FIG. 3 is a block diagram of an illustrative embodiment of a vehicle operational cost display system suitable for a conventional vehicle; and

FIG. 4 is a block diagram of an illustrative embodiment of a vehicle operational cost display method suitable for a conventional vehicle.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable users skilled in the art to practice the disclosure and are not intended to limit the scope of the claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description.

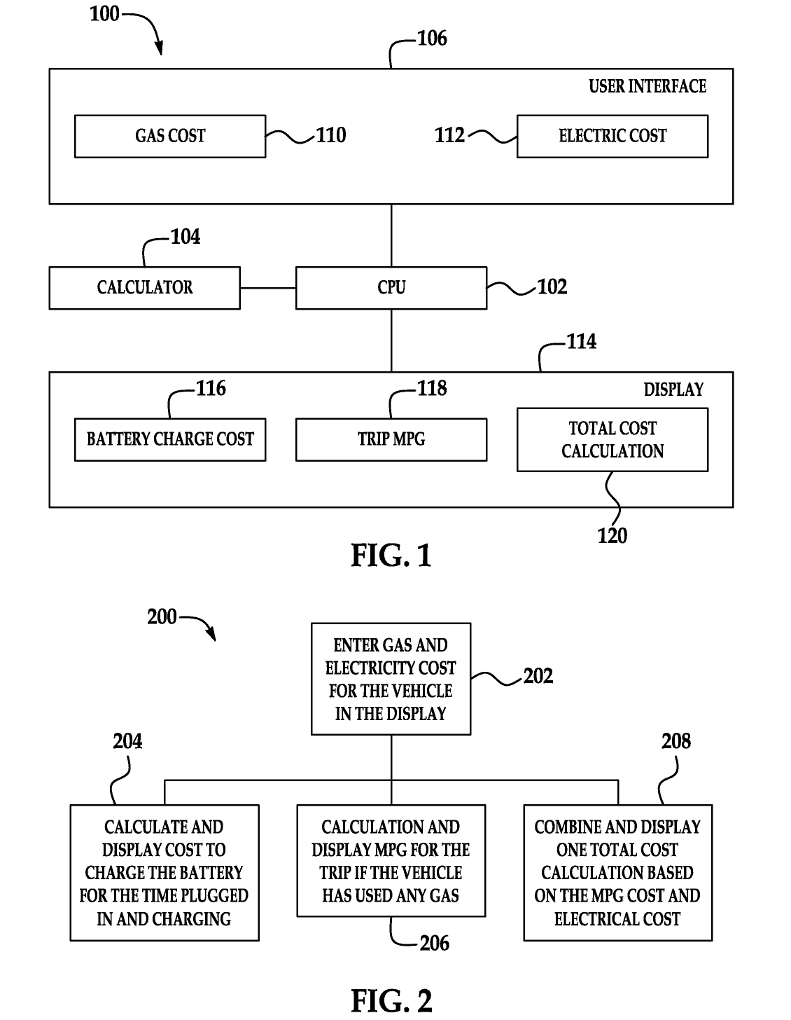

Referring initially to FIG. 1, an illustrative embodiment of a vehicle operational cost display system, hereinafter system, is generally indicated by reference numeral 100. The system 100 is adapted to calculate the operational cost of a vehicle based on fuel cost (gasoline, diesel and/or electricity cost) input and display the calculated vehicle operational cost to an operator of the vehicle. The system 100 may be applicable to hybrid electric vehicles (HEVs) such as PHEVs (plug in hybrid electric vehicles), for example and without limitation.

The system 100 may include a CPU (central processing unit) 102. The CPU 102 may have a calculator function 104. A user interface 106 may interface with the CPU 102. The user interface 106 may permit an operator to input the fuel cost (gasoline or diesel cost 110 and/or electricity cost 112) of the vehicle at the time of vehicle fueling such as at the beginning of a trip, for example and without limitation.

A display 114 may interface with the CPU 102. The display 114 may be adapted to indicate the battery charge cost 116, or the cost which is incurred to charge the vehicle battery such as at the beginning of and during the trip. The display 114 may also be adapted to display the distance per unit volume (such as miles per gallon, MPG 118, for example and without limitation) which has been achieved by the vehicle since the start of the trip. The display 114 may be adapted to display a total cost calculation 120, which is the total operational cost of the vehicle which accrues on the trip.

The CPU 102 may be adapted to calculate the battery charge cost 116 by multiplying the quantity of electrical power which is charged into the vehicle battery by the electricity cost 112 (cost of electricity per unit) which is input into the user interface 106 by the vehicle operator:

Battery charge cost=quantity of electrical power charged*electricity cost

The battery charge cost 116 may include the cumulative cost of charging the vehicle battery at all points throughout the trip. The CPU 102 may be adapted to calculate an MPG cost by dividing the distance traveled since the start of the trip by the distance per unit volume of fuel consumed (e.g., miles per gallon) which have been achieved by the vehicle since the start of the trip (trip MPG) and multiplying the resulting quotient by the gas cost per unit volume:

MPG cost=[Distance traveled/trip MPG]*gas cost/unit volume

The CPU 102 may be adapted to calculate the total trip cost by adding the MPG cost to the battery charge cost:

Total trip cost=MPG cost+Battery charge cost

In exemplary application of the system 100, a vehicle operator (not shown) enters the fuel cost (including the gas cost 110, such as dollars per unit volume of gasoline and the electricity cost 112, such as the cost of electricity per unit) in the user interface 106 at the beginning of a trip which is to be taken in an HEV. The CPU 102, via the calculator function 104, calculates the total cost calculation 120 such as by calculating the MPG cost, the battery charge cost and the total trip cost based on the MPG cost and the battery charge cost 120 as was set forth above. The CPU 102 displays the battery charge cost 116, the trip MPG 118 and the total cost calculation 120 on the display 114.

Referring next to FIG. 2, a block diagram 200 of an illustrative embodiment of a vehicle operational cost display method is shown. In block 202, the fuel cost (gas and electricity cost) for a vehicle are entered into a user interface. In block 204, the battery charge cost which accrues to charge the battery for the time the vehicle is plugged in and charging before and during a trip is calculated and displayed. In block 206, the distance per unit volume of fuel consumed (MPG) for the trip may be calculated and displayed based on the gasoline which has been consumed since the beginning of the trip. In block 208, the total cost calculation based on the MPG cost and the electrical cost may be combined and displayed.

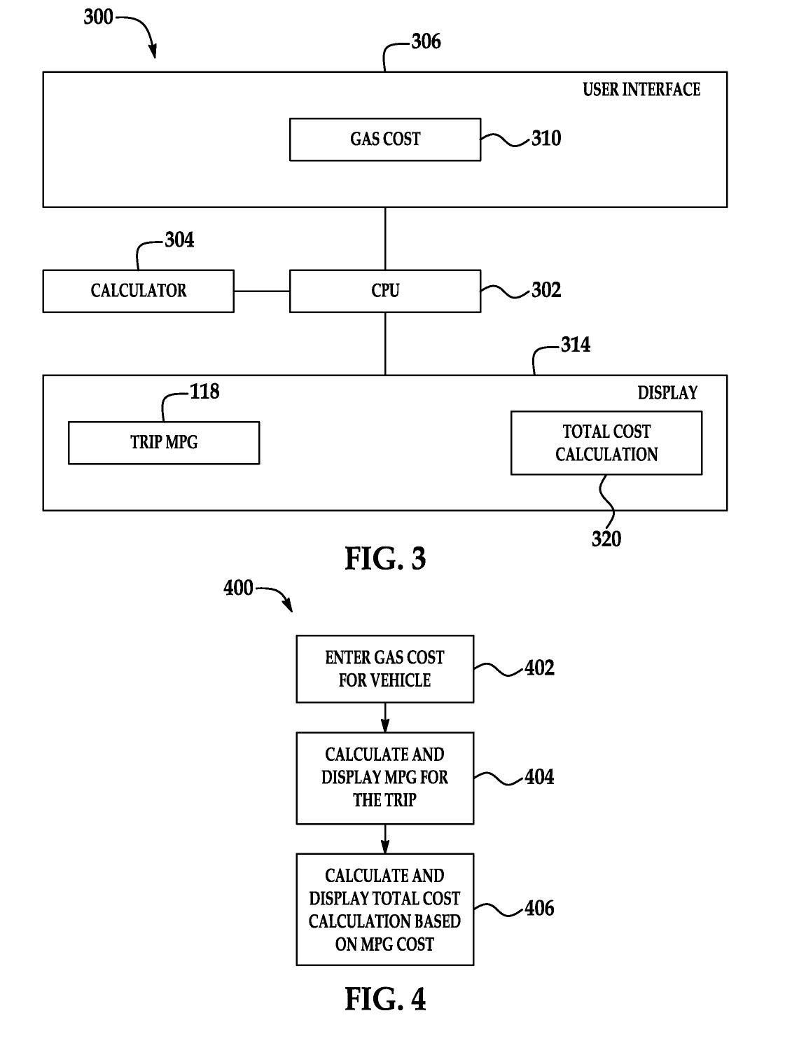

Referring next to FIG. 3, a block diagram 300 of an illustrative embodiment of a vehicle operational cost display system suitable for a conventional vehicle is shown. The system 300 is adapted to calculate the operational cost of a vehicle based on gasoline or diesel fuel cost input and display the calculated vehicle operational cost to an operator of the vehicle. The system 300 may be applicable to conventional non-electric or internal combustion (IC) vehicles.

The system 300 may include a CPU (central processing unit) 302 having a calculator function 304 and a user interface 306. The user interface 306 may permit an operator to input the gas cost 310 of the vehicle at the time of vehicle fueling such as at the beginning of and/or during a trip, for example and without limitation.

A display 314 may interface with the CPU 302. The display 314 may be adapted to display the trip MPG (distance per unit volume such as miles per gallon of gasoline consumed) 318 which has been achieved by the vehicle since the start of the trip. The display 314 may be adapted to display a total cost calculation 320, which is the total operational cost of the vehicle which accrues on the trip.

The CPU 102 may be adapted to calculate an MPG cost by dividing the distance traveled since the start of the trip by the distance per unit volume of gasoline consumed which has been achieved by the vehicle since the start of the trip (trip MPG) and multiplying the resulting quotient by the gas cost per unit volume:

MPG cost=[Distance traveled/trip MPG]*gas cost/unit volume

The total trip cost 320 may correspond to the MPG cost.

In exemplary application of the system 300, a vehicle operator (not shown) enters the gas cost 310 (such as dollars per gallon or other unit volume) in the user interface 306 at the beginning of a trip which is to be taken in a conventional internal-combustion engine vehicle. The CPU 302, via the calculator function 304, calculates the total cost calculation 320 such as by calculating the MPG cost as was set forth above. The CPU 302 displays trip MPG 318 and the total cost calculation 320 on the display 314.

Referring next to FIG. 4, a block diagram 400 of an illustrative embodiment of a vehicle operational cost display method suitable for a conventional vehicle is shown. In block 402, the gas cost of a vehicle, such as in dollars per gallon or other unit volume, is entered into a user interface. In block 404, the MPG for the trip is calculated and displayed. In block 406, the total cost calculation based on the MPG cost is calculated and displayed.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A vehicle operational cost display system, comprising:
a user interface adapted for entry of cost of fuel for operation of a vehicle;
a central processing unit interfacing with the user interface, the central processing unit having a calculator function adapted to calculate total operational cost of the vehicle based on the cost of fuel for operation of the vehicle and distance traveled; and
a display interfacing with the central processing unit, the display adapted to display the total operational cost of the vehicle.

2. The system of claim 1 wherein the user interface is further adapted for entry of cost of gasoline for operation of the vehicle and the calculator function of the central processing unit is adapted to calculate total operational cost of the vehicle based on the cost of gasoline for operation of the vehicle and distance traveled.

3. The system of claim 2 wherein the display is adapted to display a trip distance per unit volume of the vehicle.

4. The system of claim 1 wherein the user interface is adapted for entry of cost of electricity and the calculator function of the central processing unit is adapted to calculate total operational cost of the vehicle based on the cost of electricity for operation of the vehicle and distance traveled.

5. The system of claim 4 wherein the display is adapted to display a battery charge cost for charging of the vehicle.

6. The system of claim 1 wherein the user interface is adapted for entry of cost of gasoline and electricity and the calculator function of the central processing unit is adapted to calculate total operational cost of the vehicle based on the cost of gasoline and the cost of electricity for operation of the vehicle and distance traveled.

7. The system of claim 6 wherein the calculator function of the central processing unit is adapted to calculate total operational cost of the vehicle based on a trip distance per unit volume and a battery charge cost for operation of the vehicle.

8. The system of claim 7 wherein the display is adapted to display the trip distance per unit volume and the battery charge cost.

9. A vehicle operational cost display system, comprising:
a user interface adapted for entry of cost of fuel for operation of a vehicle;
a central processing unit interfacing with the user interface, the central processing unit having a calculator function adapted to calculate distance per unit volume cost of the vehicle based on the cost of fuel for operation of the vehicle, distance per unit volume of fuel consumed achieved by the vehicle and distance traveled by the vehicle; and
a display interfacing with the central processing unit, the display adapted to display the total operational cost of the vehicle based on the distance per unit volume of fuel consumed cost.

10. The system of claim 9 wherein the user interface is further adapted for entry of cost of gasoline for operation of the vehicle and the calculator function of the central processing unit is adapted to calculate total operational cost of the vehicle based on the cost of gasoline for operation of the vehicle and distance traveled.

11. The system of claim 10 wherein the display is adapted to display a trip distance per unit volume of fuel consumed for the vehicle.

12. The system of claim 9 wherein the user interface is adapted for entry of cost of electricity and the calculator function of the central processing unit is adapted to calculate total operational cost of the vehicle based on the cost of electricity for operation of the vehicle and distance traveled.

13. The system of claim 4 wherein the display is adapted to display a battery charge cost for charging of the vehicle.

14. The system of claim 9 wherein the user interface is adapted for entry of cost of gasoline and electricity and the calculator function of the central processing unit is adapted to calculate total operational cost of the vehicle based on the cost of gasoline and the cost of electricity for operation of the vehicle and distance traveled.

15. The system of claim 14 wherein the calculator function of the central processing unit is adapted to calculate total operational cost of the vehicle based on a trip distance per unit volume of fuel consumed and a battery charge cost for operation of the vehicle.

16. The system of claim 15 wherein the display is adapted to display the trip distance per unit volume of fuel consumed and the battery charge cost.

17. A vehicle operational cost display method, comprising:
entering a fuel cost for a vehicle; and
calculating and displaying a total operational cost of the vehicle based on the fuel cost, distance per unit volume of fuel consumed and distance traveled by the vehicle.

18. The method of claim 17 wherein entering a fuel cost for a vehicle comprises entering gasoline cost and electricity cost for a vehicle, and calculating and displaying a total operational cost of the vehicle comprises calculating and displaying a total operational cost of the vehicle based on the gasoline cost, the distance per unit volume of fuel consumed, the distance traveled by the vehicle and the electricity cost.

19. The method of claim 18 wherein calculating and displaying a total operational cost of the vehicle comprises calculating and displaying a total operational cost of the vehicle based on battery charge cost for charging of the vehicle and trip distance per unit volume of fuel consumed.

20. The method of claim 19 wherein calculating and displaying a total operational cost of the vehicle comprises calculating distance per unit volume of fuel consumed cost of the vehicle.

21. A vehicle operational cost system, comprising:
a human machine interface adapted for entry of vehicle operational parameters and for display of a total operational cost of a vehicle; and
a central processing unit interfacing with the human machine interface and adapted to calculate a total operational cost of the vehicle based on the vehicle operational parameters.
